(19) United States
(12) Patent Application Publication
(10) Pub. No.: US 2005/0189759 A1
(43) Pub. Date: Sep. 1, 2005

(54) Journal

(76) Inventor: Heather S. Betzold, Martinsville, IN (US)

Correspondence Address: Mark J. Young;McGuireWoods LLP, Suite 3300, 50 North Laura Street, Jacksonville, FL, 32202, US

(21) Appl. No.: 11/050,453

(22) Filed: Feb. 4, 2005

Related U.S. Application Data
(63) Continuation of application No. 10/404,873, filed on Mar. 31, 2003, now abandoned.
(60) Provisional application No. 60/369,124, filed on Apr. 1, 2002.

(51) Int. Cl. B42D 1/00

(52) U.S. Cl. 281/15.1

(57) ABSTRACT

A journal with acid-free pages has removable portions. Some pages include a plurality of removable perforated note sections. The note sections are sized to conveniently accompany photographs in standard photo processing sleeves and/or photo boxes. Notations pertinent to accompanying photographs may be written on note sections for subsequent recordation in a scrapbook or for other archival purposes. The note sections may include various icons, forms and text to facilitate the entry and arrangement of pertinent information. The note sections are aesthetically pleasing, making them suitable for prominent display in a scrapbook or photo album.

### CLAIM OF PRIORITY TO PRIOR PROVISIONAL APPLICATION

This application claims the benefit of U.S. Provisional Application 60/369,124, filed Apr. 1, 2002, the entire contents of which are hereby incorporated by reference herein.

### FIELD OF THE INVENTION

This invention relates generally to journals. More particularly, this invention relates to journals that include removable acid-free note sections that may be removed and conveniently stored with photographs.

### BACKGROUND

Memorializing events is important for many individuals. Photo albums, boxes and scrapbooks are commonly used so that their contents can be stored and conveniently accessed and perused as desired.

Unfortunately, as such individuals become busy, their memory fades and important details are forgotten. By the time they place their photos in a storage system (e.g., an album, box or scrapbook), they may have at best a vague recollection of a noteworthy event. For example, it may be impossible to remember whether a photographed child is six or eight months old, what prompted the picture, and who took the picture.

Another problem is that a typical photo album or box might not provide means for conveniently writing memories. A stored photo without a description or explanation may mean little to a third party viewer. Eventually, even a person who is the subject of the photograph or the photographer may completely forget important details surrounding the photo.

While journals and notebooks are available to help record memories, they suffer several major shortcomings. First, the paper of conventional notebooks and journals may contain acid. Over time the acid may lead to the destruction of the pages and damage photographs that come in contact with the pages. Second, the pages of conventional journals are typically too large to conveniently store with typical photo-processing sleeves or in photo boxes with photos. Third, the pages of many conventional journals are not easily removable. As memory fades, an entry in a journal may be difficult or impossible to match with a photograph. Fourth, conventional notebooks and journals lack forms that may be useful for recording information to accompany a photograph. Because conventional notebook pages are not aesthetically pleasing, they are far from ideal for featuring in scrap books and photo albums.

Accordingly, there is a need to provide a means for conveniently recording (i.e., writing) memories and safely storing the recorded memories with photos. There is an additional need to provide such a means with aesthetically pleasing removable portions that can be stored with photographs and in scrapbooks. There is a further need to provide such a means that includes thematic icons and forms to facilitate recording information. The present invention is particularly directed to meeting these needs.

### SUMMARY

The present invention solves the foregoing problems and others by providing a journal with acid-free pages and removable portions. In a preferred embodiment, some pages include a plurality of removable perforated note sections. The note sections are sized to conveniently accompany photographs in standard photo processing sleeves and/or photo boxes. Notations pertinent to accompanying photographs may be written on note sections for subsequent recordation in a scrapbook or for other archival purposes. The note sections may include various icons, forms and text to facilitate the entry and arrangement of pertinent information. Preferably, the note sections are aesthetically pleasing, making them suitable for prominent display in a scrapbook or photo album.

Other pages may include removable perforated tables, forms or charts (tables, forms and/or charts are referred to herein as “tables”) for recording information. A table may occupy an entire sheet, or one or more note sections. To the extent a table exceeds the size of standard photo processing sleeves and/or photo boxes, it may be folded when accompanying photos in such storage means. If folded in half or thirds, the table may form an envelope for storage of photographs pertinent to the table.

It is therefore an object of the present invention to provide a journal with acid-free pages and removable note sections sized to safely and conveniently accompany photographs in standard photo processing sleeves, photo boxes, photo albums, scrap books, and the like.

It is another object of the present invention to provide a journal with acid-free pages and removable note sections sized to conveniently accompany photographs in standard photo processing sleeves, photo boxes, photo albums, scrap books, and the like, wherein the pages include icons and tables to facilitate entering information and the note sections include ornamental features for an aesthetically pleasing display in photo boxes, photo albums, scrap books, and the like.

### BRIEF DESCRIPTION OF THE DRAWINGS

These and other features, aspects and advantages of the present invention will become better understood with reference to the following description and accompanying drawings, where:

FIG. 1 conceptually displays a front cover view of an exemplary spiral bound journal in accordance with a preferred implementation of the present invention.

FIG. 2 conceptually displays an exemplary journal page having a birth theme with removable note sections in accordance with a preferred implementation of the present invention.

FIG. 3 conceptually displays an exemplary journal page having a baby theme with perforated removable note sections and icons to facilitate the collection, organization and arrangement of information.

FIG. 4 conceptually displays an exemplary journal page having a baby's tenth month theme with perforated removable note sections and icons to facilitate the collection, organization and arrangement of information.

FIG. 5 conceptually displays an exemplary journal page with a removable table to facilitate the collection, organization and arrangement of information related to a baby's growth in accordance with a preferred implementation of the present invention.

FIG. 6 conceptually displays an exemplary journal page with removable table to facilitate the collection, organization and arrangement of information related to various “first time” events which happen during a baby's infancy in accordance with a preferred implementation of the present invention.

FIGS. 7, 8 and 9 conceptually display pocket-sized journals with exemplary journal pages, each having a single removable note section in accordance with an exemplary implementation of the present invention.

While the aforementioned Figures emphasize a baby theme, those skilled in the art will appreciate that the subject invention applies to various other topics and themes, including personal and family event themes such as birthdays, weddings, anniversaries, holidays, vacations, reunions, school years and other celebrations and noteworthy events. The present invention may also be used for business purposes. For example, a researcher, lawyer or investigator may enter notes on a note section and store it with a photograph for future reference. Such other uses and themes come within the scope of the present invention.

### DETAILED DESCRIPTION

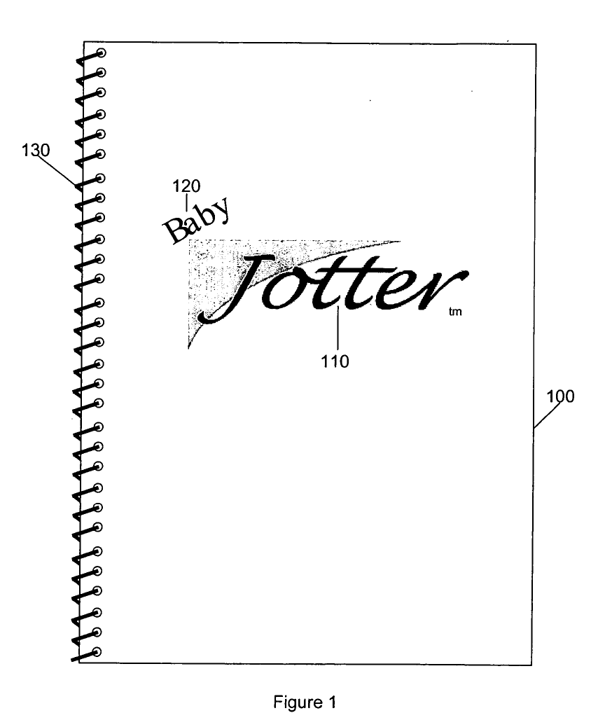

Referring to FIG. 1, a front cover view of an exemplary spiral bound journal in accordance with a preferred implementation of the present invention is conceptually shown. By way of example and not limitation, the preferred front cover 100 includes a title or trademark (e.g., Baby Jotter) 110 and 120 for the journal. The front cover 100, which may be comprised of paper, cardboard, plastic or other conventional materials used for covers as known in the art, is preferably the same size or slightly larger than the sheets (discussed below) contained within the journal. A rear cover (not shown) having a similar size and composition as the front cover 100 is preferably also provided. Sheets of the journal are preferably contained between the front cover 100 and rear cover, in a conventional manner.

A journal in accordance with the present invention is preferably bound with a binding means, such as plastic coil (i.e., spiral) binding 130 (e.g., Spiralastic® 6 mm or 7 mm 4:1 pitch plastic spiral binding available from Spiral Binding Company, Inc. <www.spiralbinding.com> of Totowa, N.J.) or other binding means known in the art. The binding means preferably allows for the journal to lay relatively flat open, to facilitate writing. A plastic coil (i.e., spiral) is preferred over wire because wire catches and bends more easily than plastic. Wire is also more likely to damage scrapbook supply carrying cases, counter tops, wood furniture and photographs.

An exemplary journal in accordance with the present invention preferably includes a plurality of acid-free paper sheets. The sheets are preferably comprised of acid-free paper such as 90 brightness/60 lb. weight paper; though papers having a different brightness, weight and/or size may be used without departing from the scope of the present invention. The 60 lb. paper as described above is believed to provide a high quality, aesthetically pleasing, durable sheet that tears well and looks nice in scrapbooks. Alternatively, archival paper, which is acid-free and lignin-free, may be used without departing from the scope of the present invention.

The paper sheets preferably have perforations to allow easy removal of a sheet and/or a portion of a sheet from the journal, as desired, by tearing the sheet along the perforations. Some sheets may include a single perforation for removal of a majority of the sheet. Other sheets may have a plurality of removable perforated sections.

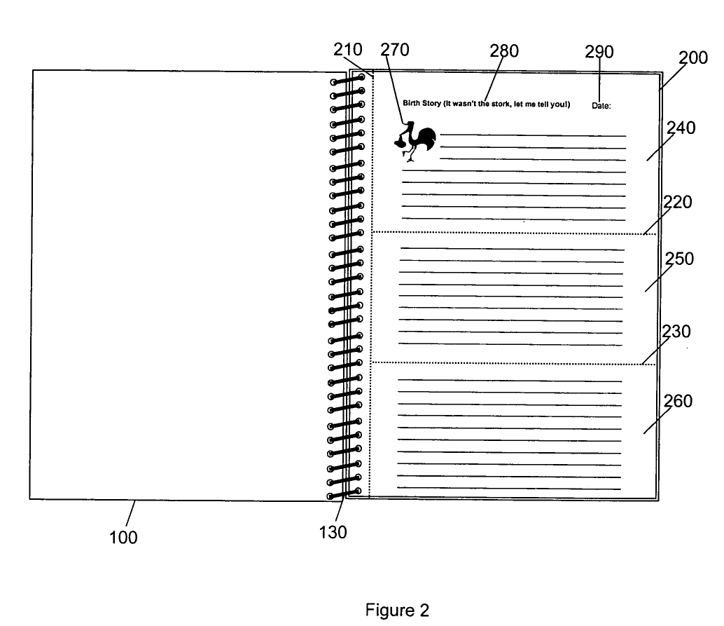

Referring now to FIG. 2, an exemplary sheet 200 of a journal in accordance with the present invention is shown. Perforated lines 210, 220 and 230 define a plurality of removable note sections 240, 250 and 260. The note sections 240, 250 and 260 are preferably sized to conveniently accompany photographs in standard photo processing sleeves and/or photo boxes. By way of example and not limitation, sheet 200 of the journal may include three perforated removable note sections 240, 250 and 260 of approximately 2.8 inches by 5.0 inches, each of which can be removed and conveniently stored with standard three inch by five inch and four inch by six inch photographs directly in their photo processing sleeves or photo boxes. A photo box is an acid-free box (typically slightly larger than a shoebox) that holds standard 4×6 photos. Photos may be removed from photo processing sleeves and placed in these boxes for safe storage until they are put into scrapbooks. Notations pertinent to accompanying photographs may be recorded on the note sections 240, 250 and 260 for subsequent recordation in a scrapbook or for other archival purposes. The note sections may include various icons, forms and/or ruled lines and text to facilitate the entry and arrangement of pertinent information.

A graphic icon 270, topic heading 280 and date 290 are provided near the top of the exemplary sheet 200 to facilitate entering information. The graphic icon 270 and topic heading 280 define a topic for addressing on one or more of the note sections 240, 250 and 260 of the sheet 200. The defined topic guides a user, helps avoid writer's block, and helps ensure that the topic is not inadvertently overlooked.

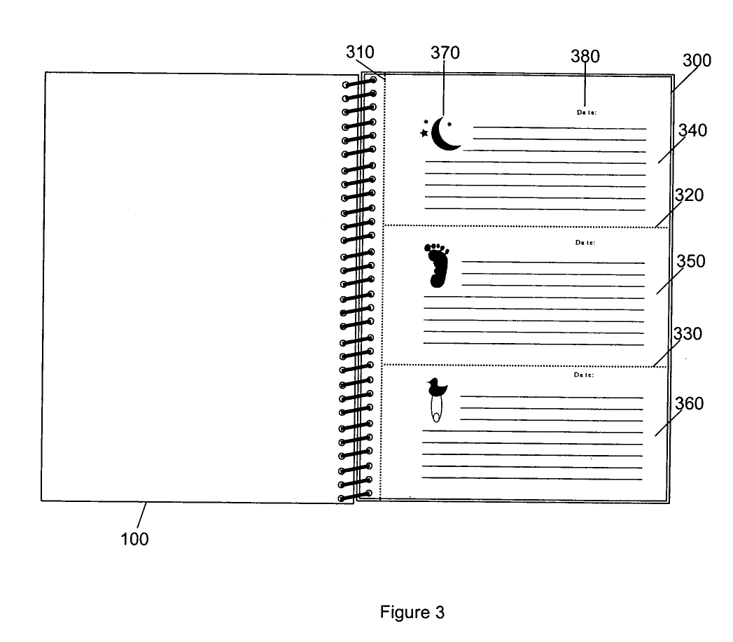

FIG. 3 conceptually depicts another exemplary sheet 300 of a journal in accordance with the present invention. As with sheet 200, perforated lines 310, 320 and 330 define a plurality of removable note sections 340, 350 and 360, which are preferably sized to conveniently accompany photographs in standard photo processing sleeves and/or photo boxes. The note sections may include graphical icons 370, ruled lines and a date to facilitate the entry and arrangement of pertinent information. In addition to serving an ornamental function, the graphical icons 370 may indirectly define or suggest a topic for addressing on one or more of the note sections 340, 350 and 360 of the sheet 300. The icon helps guide a user and reinforces the overall theme, while leaving the specific scope of coverage to the user's personal creativity and imagination.

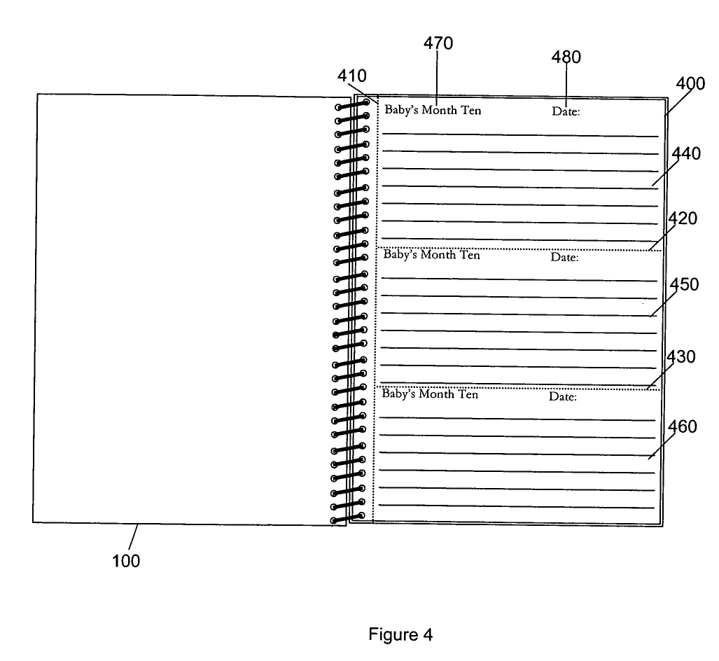

FIG. 4 conceptually depicts another exemplary sheet 400 of a journal in accordance with the present invention. As with sheet 200 and 300, perforated lines 410, 420 and 430 define a plurality of removable note sections 440, 450 and 460, which are preferably sized to conveniently accompany photographs in standard photo processing sleeves and/or photo boxes. Each note section 440, 450 and 460 includes a heading 470 (e.g., Baby's Month Ten), ruled lines and a date 480 to guide the entry and arrangement of pertinent information. The heading serves as a gentle reminder, ensuring that the topic receives attention, while leaving the specific entries to the user's personal creativity and imagination.

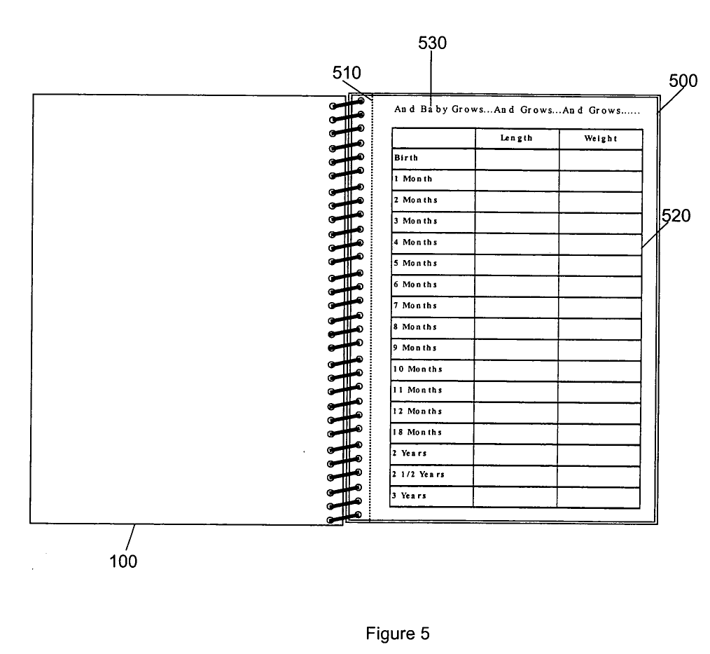

FIG. 5 conceptually depicts another exemplary sheet 500 of a journal in accordance with the present invention. Perforated line 510 define a removable section 520, which includes (by way of example and not limitation) a table. Though the removable section may exceed the size of standard photo processing sleeves and/or photo boxes, it may be folded to accompany photos in such storage means. If folded in half or in thirds, the table may form a protective envelope for storage of photographs. Alternatively, the table may be displayed in a scrapbook or photo album. The exemplary table solicits very specific information, i.e., length and weight, ensuring that it is recorded for posterity, but leaving little (if anything) to the imagination and creativity of the user.

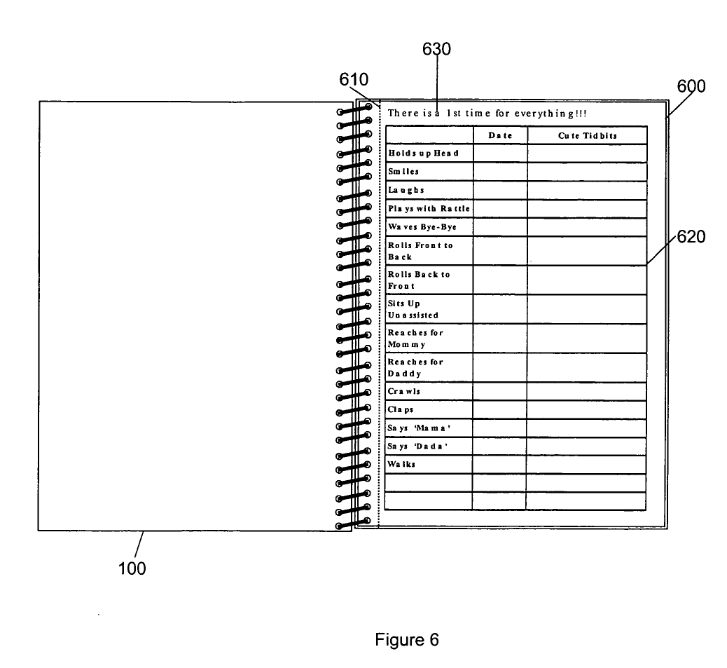

FIG. 6 conceptually depicts another exemplary sheet 600 of a journal in accordance with the present invention. As with sheet 500, a perforated line 610 defines a removable section 620, which includes (by way of example and not limitation) another table. While the removable section may exceed the size of standard photo processing sleeves and/or photo boxes, it too may be folded to accompany photos in such storage means or featured on a page of a scrapbook or photo album. This exemplary table solicits certain information, ensuring that it is recorded for posterity, as does the table on exemplary sheet 500. However, this table, particularly the column entitled “Cute Tidbits”, leaves much to the imagination and creativity of the user.

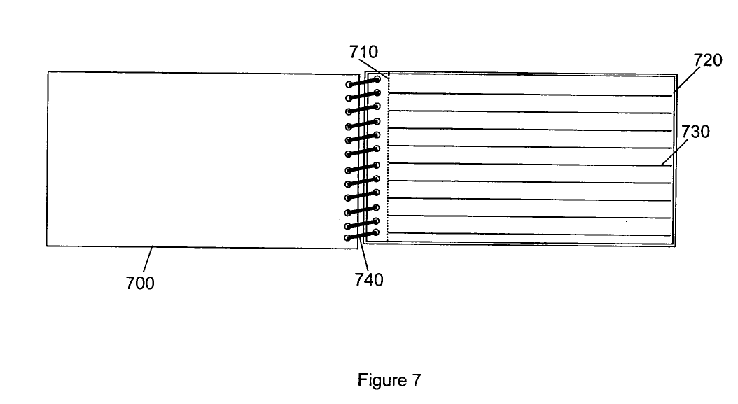

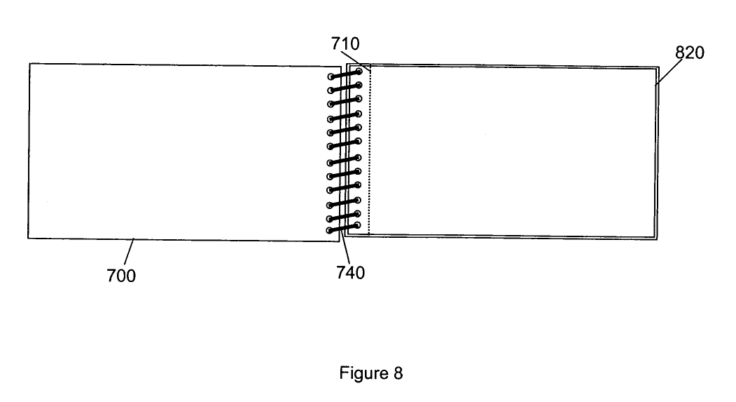

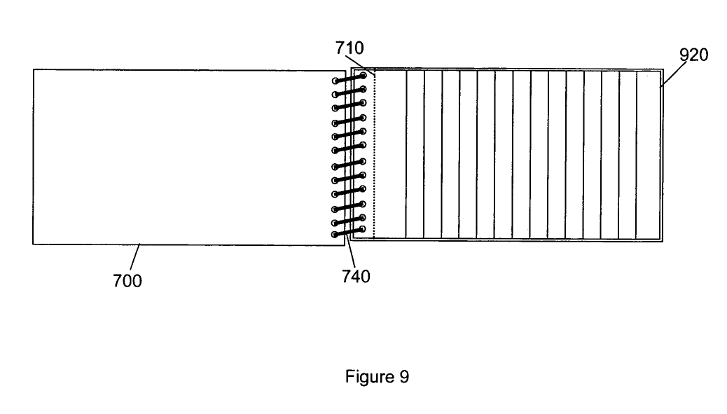

FIG. 7 conceptually depicts an alternative embodiment of the present invention (i.e., a pocket-sized journal). A front cover 700 and back cover are provided. Binding 740 is also provided. Sheet 720 is preferably approximately the size of a standard photograph. Perforated line 710 defines a removable lined note section 730. The sheet may also be blank, such as sheet 820 in FIG. 8, or have lines parallel to the spiral binding, such as sheet 920 in FIG. 9. The note section is preferably sized to conveniently accompany photographs in standard photo processing sleeves and/or photo boxes. By way of example and not limitation, note section 730 may be approximately 2.8 inches by 5.0 inches, which can be removed and conveniently stored with standard three inch by five inch and four inch by six inch photographs directly in their photo processing sleeves or photo boxes. The journal would preferably include a plurality (e.g., 50) of such sheets, all lined the same way, blank or any combination of any of the foregoing. While the sheets 720, 820 and 920 are shown without titles, tables or graphical icons, such items may be included on any or all of the sheets without departing from the scope of the present invention.

Some other sheets may include removable perforated tables, forms, charts or other graphical displays for recording information, which may occupy nearly the entire sheet, or one or more portions.

A journal in accordance with the present invention may also include an introduction on how to use the journal. Additionally, a journal in accordance with the present invention may include one or more removable blank sheets, which may include removable note sections with and/or without ruled lines. These sheets and note sections may be used to record whatever information a user wants to record, such as, for example, overflow from previous formatted sheet or section. The blank sheets and note sections may be interspersed with other pages and note sections of the journal. For example, approximately every other page or every third, fourth or fifth page may be a blank sheet.

Removable note sections such as 240-260, 340-360 and 440-460, may be removed and stored with photographs. Later, the photographs may be glued or otherwise placed into a scrapbook. A narrative based on memories written on the note sections may also be neatly written in the scrapbook. Key information may be obtained from the note sections. Alternatively, the note sections may be included in the scrapbook. Alternatively,

A method of using a journal in accordance with a preferred implementation of the present invention may include the following steps:
(1) Entering information on a page, note section or table, preferably using acid-free ink.
(2) Removing the page, note section or table from the journal.
(3) Storing the page, note section or table as removed from the journal.

The third step may further include storing the page, note section or table as removed from the journal with a photograph. A fourth step may be entering the information or commentary based on the information in a scrapbook. An alternative fourth step may be placing the note section directly into the scrapbook, such as with tape, glue or some other adhesive.

Thus, for example, note sections may easily be removed and stored loosely with photos for reference. A user may write down his or her thoughts and memories of certain events on the note sections soon after the events happen so that the most of the information is recorded. Subsequently, the user may refer to the note sections for writing more formal entries in a scrapbook. As the note sections are made of acid-free paper, they should not cause damage to the photos, even after considerable time has passed.

With a conventional journal a user would not be able to conveniently remove and store pages or note sections with photos. Eventually the user may not remember where the information is stored when he or she gets around to entering the photos in a scrapbook. In some cases it could be years down the road before he or she scrapbooks his or her photos. If the pages of a conventional journal are removed and stored with photos, acid in the paper may damage the photos. Also, such pages may not be easily removed and may tear unevenly. Such pages would also not fit neatly within photo processing sleeves without extensive folding. Furthermore, as such pages are not intended for featuring in a scrapbook, they are unlikely to be aesthetically pleasing.

The foregoing detailed description of particular preferred embodiments and implementations of the present invention, which should be read in conjunction with the accompanying drawings, is not intended to limit the enumerated claims, but to serve as particular examples of the claimed invention. Those skilled in the art should appreciate that they can readily use the concepts and specific embodiments and implementations disclosed as bases for modifying or designing other systems and methods for carrying out the same purposes of the present invention. Those skilled in the art should also realize that such equivalent systems and methods do not depart from the spirit and scope of the invention as claimed.

1. A journal comprised of:
a plurality of sheets comprised of acid-free paper, each of said sheets having a removable portion, and
a means for binding said sheets.

2. A journal according to claim 1 wherein at least one of said removable portions is approximately the size of a photograph.

3. A journal according to claim 1 wherein at least one of said removable portions is approximately three inches by five inches.

4. A journal according to claim 3 wherein said removable portion is approximately 2.8 inches by 5.0 inches.

5. A journal according to claim 1 wherein at least one removable portion has a title.

6. A journal according to claim 1 wherein at least one removable portion has a date.

7. A journal according to claim 1 wherein at least one removable portion has a graphical icon.

8. A journal according to claim 1 wherein at least one removable portion has a table.

9. A journal according to claim 1 wherein the plurality of sheets are lignin free.

10. A journal according to claim 1 wherein perforations define each removable portion,
at least one removable portion has a title,
at least one of said removable portions is approximately three inches by five inches,
at least one removable portion has a title,
at least one removable portion has a date,
at least one removable portion has a graphical icon, and
at least one removable portion has a table.

11. A journal according to claim 10 wherein the plurality of sheets are lignin free.

12. A method of journaling using a journal according to claim 1, said method including steps of:
writing information on a removable portion,
removing the removable portion upon which information is written,
storing the removable portion.

13. The method according to claim 12, wherein the step of storing the removable portion further comprises storing the removable portion with a photograph.

14. The method according to claim 12, wherein the step of storing the removable portion further comprises storing the removable portion with a photograph in a photograph processing sleeve.

15. The method according to claim 12, wherein the step of storing the removable portion further comprises storing the removable portion in a scrapbook.
